(19) United States
(12) Patent Application Publication
(10) Pub. No.: US 2007/0022423 A1
(43) Pub. Date: Jan. 25, 2007

(54) Enhanced method for handling preemption points

(76) Inventors: Reinder J. Bril, Waalre (NL); Dietwig Jos Clement Lowet, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/575,576

(22) PCT Filed: Nov. 4, 2004
(86) PCT No.: PCT/IB04/52312

§ 371 Date: Apr. 11, 2006

Related U.S. Application Data
(60) Provisional application No. 60/518,007, filed on Nov. 6, 2003.

(51) Int. Cl. G06F 9/46

(52) U.S. Cl. 718/102

(57) ABSTRACT

A method and apparatus is provided for use by a scheduler of a multi-processing data processing system to select task preemption points based on main memory requirements and exclusive resource usage that is cost-effective and that maintains system consistency and, in particular, enables additional preemption strategies in which: matching synchronization primitives do not span a preemption point, i.e., sub job boundary; for a particular resource Rₖ, all intervals/sub-jobs of all tasks that use this resource (and protect it by using synchronization primitives) are either all preemptible or all non-preemptible—i. in case they are all preemptible the synchronization primitives must be executed, and ii. in case they are all non-preemptible, it is not necessary to execute the synchronization primitives; preemption of a subset of tasks is limited to the preemption points of this subset while allowing arbitrary preemption of all the other tasks; and preemption of a subset of tasks is limited to their preemption points, preemption of the other tasks is limited to a subset of their preemption points, while allowing arbitrary preemption of their remaining intervals. That is, the present invention is a main memory based preemption technique that is not restricted to preemption only at predetermined preemption points and that avoids deadlock due to exclusive use of resources.

The present invention relates to a resource management method and apparatus that is particularly, but not exclusively, suited to resource management of real-time systems.

The management of memory is a crucial aspect of resource management, and various methods have been developed to optimize its use. A method of handling preferred preemption points discussed in the literature [1], [2], [3] has been proposed [4] as a means to improve the efficiency of data processing systems by generalizing the use of preemption points to the management of main memory, especially in real-time systems. In this approach to memory management, rather than preempting tasks at arbitrary moments during their execution, those tasks are preferably only preempted at dedicated preemption points based on their memory usage.

In the following description, suspension of a task is referred to as task preemption, or preemption of a task, and the term “task” is used to denote a unit of execution that can compete on its own for system resources such as memory, CPU, I/O devices, etc. A task can be viewed as a succession of continually executing jobs, each of which comprises one or more sub-jobs. For example, a task could comprise “demultiplexing a video stream”, and involve reading in incoming streams, processing the streams and outputting corresponding data. These steps are carried out with respect to each incoming data stream, so that reading, processing and outputting with respect to a single stream corresponds to performing one job. Thus, when there is a plurality of packets of data to be read in and processed, the job would be performed a corresponding plurality of times. A sub-job can be considered to relate to a functional component of the job.

A known method of scheduling a plurality of tasks in a data processing system requires that each sub-job of a task have a set of suspension criteria, called suspension data, that specifies the processing preemption points and corresponding conditions for suspension of a sub-job based on its memory usage [4] [5]. The amount of memory that is used by the data processing system is thus indirectly controlled by this suspension data, via these preemption points, which specify the amounts of memory required at these preemption points in a job's execution.

Thus, these preemption points can be utilized to avoid data processing system crashes due to a lack of memory. When a real-time task is characterized as comprising a plurality of sub-jobs, its preemption points preferably or typically coincide with the sub-job boundaries of the task. However, care must be taken that the tasks themselves do no suspend themselves during a sub-job. Depending on the implementation, this suspension of by a non-preemptible sub-job can result in deadlock or in the use of too much memory.

Data indicative of memory usage of a task conforming to the suspension data associated with each sub-job of a task can, for example, be embedded into a task via a line of code that requests a descheduling event, specifying that a preemption point has been reached in the processing of the task, i.e., a sub-job boundary has been reached. That is, the set of start points of the sub-jobs of a task constitute a set of preemption points of that task. The j^{th} preemption point P_{i,j} of a task τᵢ is characterized by information related to the preemption point itself and information related to the succeeding non-preemptible sub-job interval I_{i,j} between the j^{th} preemption point and the next preemption point, i.e., the (j+1)^{th} preemption point.

At run time, a task informs the controlling operating system when it arrives at preemption points, e.g. when it starts a sub-job, switches between sub-jobs, and completes a sub-job, and the operating system decides when and where execution of a task is preempted. Ideally, preemption may occur at a preemption point or at any other point during the execution of a task.

However, in addition to the deadlock problem described above, such flexibility of choice of preemption comes at the cost of consistency under the following conditions:
(1) preemption of a subset of tasks is limited to the preemption points of this subset while allowing arbitrary preemption of all the other tasks; and
(2) preemption of a subset of tasks is limited to their preemption points, preemption of the other tasks is limited to a subset of their preemption points, while allowing arbitrary preemption of their remaining intervals.
   When intervals of tasks with preemption points are preempted arbitrarily, the predictability of those subsystems may be degraded because the design, analysis and testing of the components was based on the assumption that intervals of tasks are only preempted at preemption points. The resulting system can become inconsistent when arbitrary preemption of task intervals takes place because exclusive access to resources is not guaranteed.

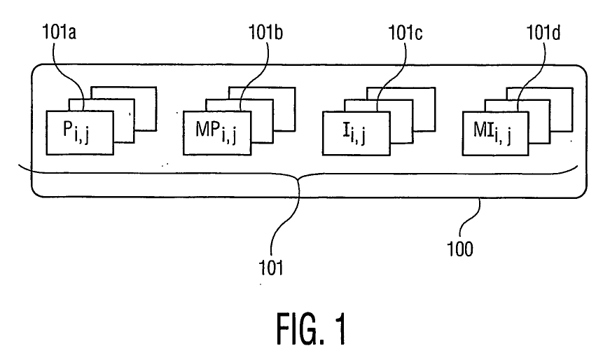

A prior art preemption point approach based on main memory requirements that does not jeopardize consistency of the system, necessarily limits the preemption of all tasks to their preemption points. As is known in the art, a component (e.g. a software component, which can comprise one or more tasks) can have a programmable interface that comprises the properties, functions or methods and events that the component defines [6]. For purposes of discussion, a task τᵢ is assumed to be accompanied by an interface 100 that includes, at a minimum, main memory data required by the task, MP_{i,j} 101b, as illustrated in FIG. 1. Furthermore, it is assumed that preemption points are defined such that matching synchronization primitives do not span a sub-job, boundary (or a preemption point).

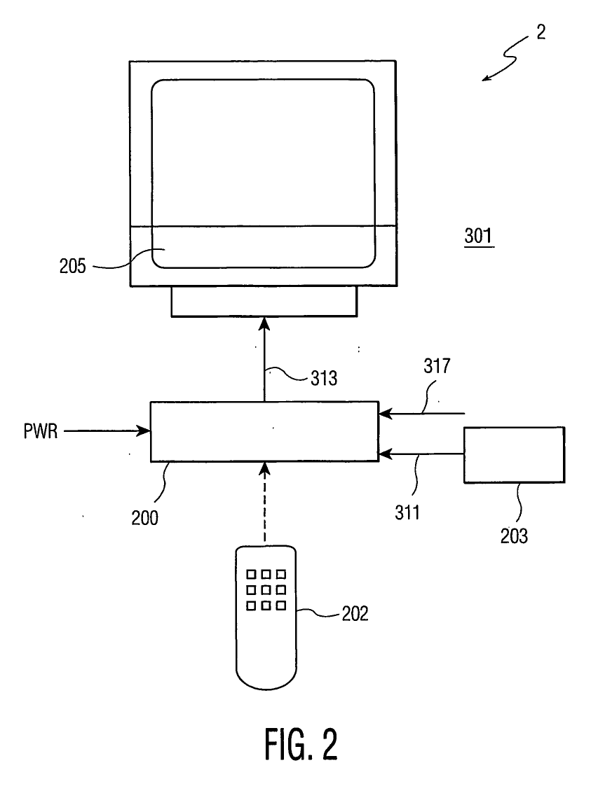

For the purposes of discussion, a task is assumed to be periodic and real-time, and characterized by a period T and a phasing F, where 0<=F<T, which means that a task comprises a sequence of sub-jobs, the same sequence being repeated periodically, each of which is released at time F+nT, where n=0 . . . N. As an example only and as illustrated in FIG. 2, set-top box 200 is assumed to execute three tasks—(1) display menu on the User Interface 205, (2) retrieve text information from a content provider 203, and (3) process some video signals—and each these 3 tasks is assumed to comprise a plurality of sub-jobs. For ease of presentation, it is assumed that the sub-jobs are executed sequentially.

At least some of these sub-jobs can be preempted and the boundaries between these sub-jobs that can be preempted provide preemption points and are summarized in Table 1:

TABLE 1

| | | Number of preemptable |
|---|---|---|
| Task | | sub-jobs of task τᵢ |
| τᵢ | Task description | m(i) |
| τ₁ | display menu on the GUI | 3 |
| τ₂ | retrieve text information from | 2 |
| | content provider | |
| τ₃ | process video signals | 2 |

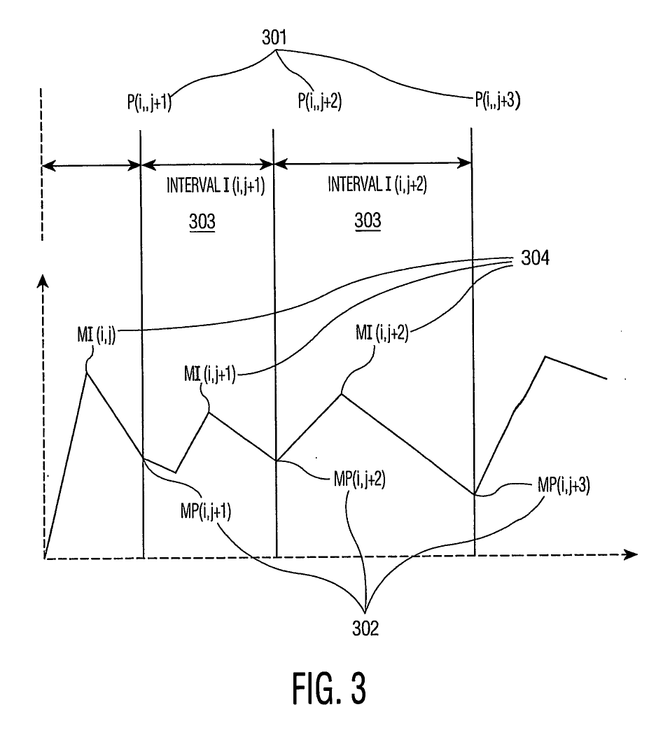

Referring also to FIG. 3, for each task, the suspension data 101 comprises: information relating to a preemption-point P_{i,j} 301, such as the maximum amount of memory MP_{i,j} 302 required at the preemption point, and information relating to the interval I_{i,j} 303 between successive preemption-points, such as the worst-case amount of memory MI_{i,j} 304 required in an intra-preemption point interval (i represents task τᵢ and j represents a preemption point).

More specifically, suspension data 101 comprises data specifying
1. preemption point j of the task τᵢ (P_{i,j}) 101a;
2. maximum memory requirements of task τᵢ, MP_{i,j}, at preemption point j of that task, where 1≦j≦m(i) 101b;
3. interval, I_{i,j}, between successive preemption points j and (j+1) corresponding to sub-job j of task τᵢ, where 1≦j≦m(i) 101c; and
4. maximum (i.e. worst-case) memory requirements of task τᵢ, MI_{i,j}, in the interval j of that task, where 1≦j≦m(i) 101d.

Table 2 illustrates the suspension data 101 for the current example (each task has its own interface, so that in the current example, the suspension data 101 corresponding to the first task τ₁ comprises the data in the first row of Table 2, the suspension data 101 corresponding to the second task τ₂ comprises the second row of Table 2, etc.):

TABLE 2

| Task τᵢ | MP_{i,1} | MI_{i,1} | MP_{i,2} | MI_{i,2} | MP_{i,3} | MI_{i,3} |
|---|---|---|---|---|---|---|
| τ₁ | 0.2 | 0.7 | 0.2 | 0.4 | 0.1 | 0.6 |
| τ₂ | 0.1 | 0.5 | 0.2 | 0.8 | — | — |
| τ₃ | 0.1 | 0.2 | 0.1 | 0.3 | — | — |

Suppose a set-top box 200 is equipped with 1.5 Mbytes of memory. Under normal, or non-memory based preemption conditions, this set-top box 200 behaves as follows.

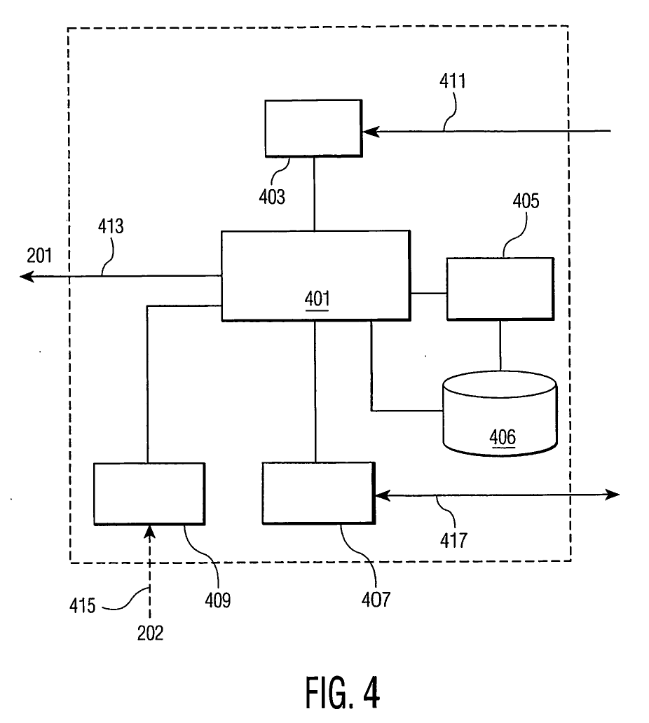

Referring now to FIG. 4, a processor 401 may be expected to schedule tasks according to some sort of time slicing or priority based preemption, meaning that all 3 tasks run concurrently, i.e. effectively at the same time. It is therefore possible that each task can be scheduled to run its most memory intensive sub-job at the same time. The worst-case memory requirements of these three tasks, M^{P}, is given by:

$${M}^{P} = {\sum }_{i = 1}^{3} {max}_{j = 1}^{m ( i )} {MI}_{i , j} \qquad ( Equation 1 )$$

For tasks τ₁, τ₂ and τ₃ M^{p} is thus the maximum memory requirements of τ₁ (being MI_{1,1}) plus the maximal memory requirements of task τ₂ (being MI_{2,2}) plus the maximal memory requirements of task τ₃ (being MI_{3,2}). These maximum requirements are indicated by the Table 2 entries in bold:
M^{P}=0.7+0.8+0.3=1.8 Mbytes.

This exceeds the memory available to the set-top box 200 by 0.3 Mbytes, so that, in the absence of any precautionary measures, and if these sub-jobs are to be processed at the same time, the set-top box 200 crashes.

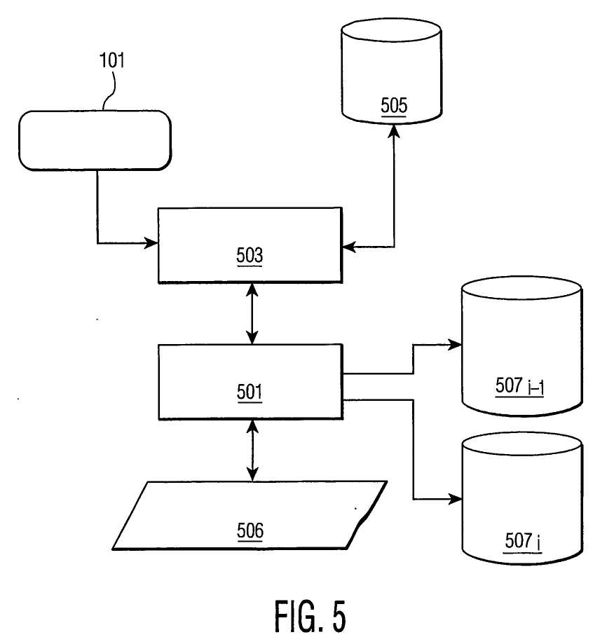

Referring now to FIG. 5, suppose tasks are scheduled in accordance with a scheduling algorithm and a data structure is maintained for each task τᵢ after it has been created. Suppose further that a scheduler 501 employs a conventional priority-based, preemptive scheduling algorithm, which essentially ensures that, at any point in time, the currently running task is the one with the highest priority among all ready-to-run tasks in the system. As is known in the art, the scheduling behavior can be modified by selectively enabling and disabling preemption for the running, or ready-to-run, tasks.

A task manager 503 receives the suspension data 101 corresponding to a newly received task and evaluates whether preemption is required or not and if it is required, passes this newly received information to the scheduler 501, requesting preemption. Suppose details of the tasks are as defined in Table 2, and assume that task τ₁ (and only τ₁) is currently being processed and that the scheduler is initially operating in a mode in which there are no memory-based constraints.

Suppose now that task τ₂ is received by the task manager 503, which reads the suspension data 101 from its interface Int₂ 100, and identifies whether or not the scheduler 501 is working in accordance with memory-based preemption. Since, in this example, it is not, the task manager 503 evaluates whether the scheduler 501 needs to change to memory-based preemption. This therefore involves the task manager 503 retrieving worst case suspension data corresponding to all currently executing tasks (in this example task τ₁) from a suspension data store 505, evaluating Equation 1 and comparing the evaluated worst-case memory requirements with the memory resources available. Continuing with the example introduced in Table 2, Equation 1, for τ₁ and τ₂, is:

$${M}^{P} = {\sum }_{i = 1}^{2} {max}_{j = 1}^{m ( i )} {MI}_{i , j} = 0.7 + 0.8 = 1.5 Mbytes$$

This is exactly equal to the available memory, so there is no need to change the mode of operation of the scheduler 501 to memory-based preemption (i.e. there is no need to constrain the scheduler based on memory usage). Thus, if the scheduler 501 were to switch between task τ₁ and task τ₂—e.g. to satisfy execution time constraints of task τ₂, meaning that both tasks effectively reside in memory at the same time—the processor never accesses more memory than is available.

Next, and before tasks τ₁ and τ₂ have completed, another task τ₃ is received. The task manager 503 reads the suspension data 101 from interface Int₃ associated with the task τ₃, evaluating whether the scheduler 501 needs to change to memory-based preemption. Assuming that the scheduler 501 is multi-tasking tasks τ₁ and τ₂, the worst case memory requirements for all three tasks is now

$${M}^{P} = {\sum }_{i = 1}^{2} {max}_{j = 1}^{m ( i )} {MI}_{i , j} = 0.7 + 0.8 + 0.3 = 1.8 Mbytes$$

This exceeds the available memory, so the task manager 503 requests and retrieves memory usage data MP_{i,j}, MI_{i,j} 101b, 101d for all three tasks from the suspension data store 505, and evaluates whether, based on this retrieved memory usage data, there are sufficient memory resources to execute all three tasks. This can be ascertained through evaluation of the following equation:

$$\begin{matrix}{M}^{ D} = {\sum }_{i = 1}^{3} {max}_{j = 1}^{m ( i )} {MP}_{i , j} + {max}_{i = 1}^{3} \\ ( {max}_{j = 1}^{m ( i )} {MI}_{i , j} - {max}_{j = 1}^{m ( i )} {MP}_{i , j} ) \\ = 0.2 + 0.2 + 0.1 + max ( 0.7 - 0.2 , 0.8 - 0.2 , 0.3 - 0.1 ) \\ = 0.5 + 0.6 \\ = 1.1 Mbytes .\end{matrix} \qquad ( Equation 2 )$$

This memory requirement is lower than the available memory, meaning that, provided the tasks are preempted only at their preemption points, all three tasks can be executed concurrently.

Accordingly, the task manager 503 invokes “memory-based preemption mode” by instructing the tasks to transmit deschedule instructions to the scheduler 501 at their designated preemption points MP_{i,j}. In this mode, the scheduler 501 allows each task to run non-preemptively from one preemption point to the next, with the constraint that, at any point in time, at most one task at a time can be at a point other than one of its preemption points. Assuming that the newly arrived task starts at a preemption point, the scheduler 501 ensures that this condition holds for the currently running tasks, thereby constraining all but one task to be at a preemption point.

Thus, in the known memory-based preemption mode, the scheduler 501 is only allowed to preempt tasks at their memory preemption points (i.e. in response to a deschedule request from the task at their memory-based preemption points). The possibility of deadlock remains if a task suspends itself because it wants to wait for exclusive use of a resource that is held by another task. This can occur when the other task is preempted while holding a lock on the resource. This can be prevented by ensuring that a task does not hold a lock on a resource at a preemption point, or in other words, the synchronisation primitives that protect a resource do not span a preemption point, i.e., a sub-job boundary.

When one of the tasks has terminated, the terminating task informs the task manager 503 that it is terminating, causing the task manager 503 to evaluate Equation 1 and if the worst case memory usage (taking into account removal of this task) is lower than that available to the scheduler 501, the task manager 503 can cancel memory-based preemption, which has the benefit of enabling the system to react faster to external events (since the processor is no longer “blocked” for the duration of the sub-jobs). In general, termination of a task is typically caused by its environment, e.g. a switch of channel by the user or a change in the data stream of the encoding applied (requiring another kind of decoding), meaning that the task manager 503 and/or scheduler 501 should be aware of the termination of a task and probably even instruct the task to terminate.

It should be noted that, when invoked, memory-based preemption constraints are obligatory.

The tasks have been described as software tasks, but a task can also be implemented in hardware. Typically, a hardware device (behaving as a hardware task) is controlled by a software task, which allocates the (worst-case) memory required by the hardware device, and subsequently instructs the hardware task to run. When the hardware task completes, it informs the software task, which subsequently de-allocates the memory. Hence, by having a controlling software task, hardware tasks can simply be dealt with as described above.

This approach, restricted as it is to preempting tasks only at preemption points, does not always allow for a best choice of sub-job preemption, does not always obtain the highest system speed-up thereby, and can result in deadlock if care is not been taken to handle synchronization primitives correctly.

The present invention provides a method and apparatus for the selection of preemption points based on main memory requirements that is more cost-effective and that maintains system consistency and, in particular, enables additional preemption strategies in which:
1. matching synchronization primitives do not span a sub-job boundary;
2. for a particular resource Rₖ, all intervals/sub-jobs of all tasks that use this resource (and protect it by using synchronization primitives) are either all preemptible or all non-preemptible—
   i. in case they are all preemptible the synchronization primitives must be executed, and
   ii. in case they are all non-preemptible, it is not necessary to execute the synchronization primitives;
3. preemption of a subset of tasks is limited to the preemption points of this subset while allowing arbitrary preemption of all the other tasks; and
4. preemption of a subset of tasks is limited to their preemption points, preemption of the other tasks is limited to a subset of their preemption points, while allowing arbitrary preemption of their remaining intervals.
   That is, the present invention is a main memory based preemption technique that is not restricted to preemption only at predetermined preemption points and that avoids the deadlock problem of the prior art preemption point approach.

This invention not only resolves a problem with a prior art memory based preemption point technique, as described above, but has the following advantages. It allows trading memory for CPU cycles by being able to preempt intervals arbitrarily while still guaranteeing system consistency, i.e.,
it obviates the need for system calls for concurrency control when the system doesn't preempt intervals; and
it allows preemption of intervals when the task set would not be schedulable without preemptions.
   The advantage of the present invention over the prior art memory based preemption point technique can be further explained by considering two implications of blocking. First, blocking may reduce the worst-case response time of the blocking task (when it concerns the last sub-job of that task). Second, it may increase the worst-case response time of higher priority tasks (when that blocking time is the largest blocking time of all tasks with a lower priority that the blocked task). Preempting an interval may therefore increase the worst-case response time of the preempted task and decrease the worst-case response time of tasks with a higher priority than the blocking task. In particular situations, preempting an interval may therefore make a task-set schedulable.

The foregoing and other features and advantages of the invention will be apparent from the following, more detailed description of preferred embodiments as illustrated in the accompanying drawings in which reference characters refer to the same parts throughout the various views.

FIG. 1 illustrates a schematic diagram of components of a task interface according to an embodiment of the present invention;

FIG. 2 illustrates a schematic diagram of an example of a digital television system in which an embodiment of the present invention is operative;

FIG. 3 illustrates a schematic diagram of the relationships between components of the task interface illustrated in FIG. 1.

FIG. 4 illustrates components constituting the set top; box of FIG. 2.

FIG. 5 illustrates components of the processor of the set-top box illustrates in FIG. 2 and FIG. 4.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

High volume electronic (HVE) consumer systems, such as digital TV sets, digitally improved analog TV sets and set-top boxes (STBs) must provide real-time services while remaining cost-effective and robust. Consumer products, by their nature, are heavily resource constrained. As a consequence, the available resources have to be used very efficiently, while preserving typical qualities of HVE consumer systems, such as robustness, and meeting stringent timing requirements. Concerning robustness, no one expects, for example, a TV set to fail with the message “please reboot the system”.

Significant parts of the media processing in HVE consumer systems are implemented in on-board software that handles multiple concurrent streams of data, and in particular must very efficiently manage system resources, such as main memory, in a multi-tasking environment. Consider a set-top box as an example of an HVE consumer system requiring real-time resource management. Conventionally, as illustrated in FIG. 2, a set-top box 200 receives input for television 201 from a content provider 203 (a server or cable) and from a user interface 205. The user interface 205 comprises a remote control interface for receiving signals from a user-controlled remote device 202, e.g., a handheld infrared remote transmitter. The set-top box 200 receives at least one data stream from at least one of an antenna and a cable television outlet, and performs at least one of processing the data stream or forwarding the data stream to television 201. A user views the at least one data stream displayed on television 201 and via user interface 205, makes selections based on what is being displayed. The set-top box 200 processes the user selection input and based on this input may transmit to the content provider 203 the user input, along with other information identifying the set-top box 200 and its capabilities.

FIG. 4 illustrates a simplified block diagram of an exemplary system 400 of a typical set-top box 200 that may include a control processor 401 for controlling the overall operation of set-top box 200. The control processor 401 is coupled to a television tuner 403, a memory 405, a long term storage device 406, a communication interface 407, and a remote interface 409. The television tuner 403 receives television signals over transmission line 411 and these signals may originate from at least one of an antenna (not shown) and a cable television outlet (not shown). The control processor 401 manages the user interface 205, providing data, audio and video output to the television 201 via line 413. The remote interface 409 receives signals from the remote control via the wireless connection 415. The communication interface 407 interfaces between the set-top box 200 and at least one remote processing system, such a Web server, via data path 417. The communication interface 407 is at least one of a telephone modem, an Integrate Services Digital Network (ISDN) adapter, a Digital Subscriber Line (xDSL), a cable television modem, and any other suitable data communication device. The exemplary system 400 of FIG. 4 is for descriptive purposes only. Although the description may refer to terms commonly used in describing particular set-top boxes 200, the description and concepts equally apply to other control processors, including systems having architectures dissimilar to that shown in FIG. 4.

The control processor 401, in a preferred embodiment, is configured to process a plurality of real-time tasks relating to the control of the set-top box 200, including changing channels, selection of a menu option displayed on the user interface 205, decoding incoming data streams, recording incoming data streams using the long term storage device 406 and replaying them, etc. The operation of the set-top box is determined by these real-time control tasks based on characteristics of the set-top box 100, incoming video signals via line 411, user inputs via user interface 205, and any other ancillary input.

As illustrated in FIG. 1, each real-time task i controlled by the control processor 401, comprises at least one sub-job or preemption point P_{i,j} having a corresponding set of suspension data comprising maximum amount of memory required M^{k}_{i,j} 101. That is, the set of start points P_{i,j} of the sub-jobs of the at least one task i constitute a set of preemption points P_{i,j} of that task. The j^{th} preemption point P_{i,j} of a task i is characterized by information related to the preemption point itself and information related to the succeeding program interval I_{i,j} between the j^{th} preemption point and the next preemption point, i.e., the (j+1)^{th} preemption point. In a preferred embodiment, the following approach to allows the control processor to decide if, processing during the succeeding program interval, I_{i,j} can be preempted arbitrarily during that interval:
1. matching synchronization primitives do not span a sub-job boundary;
2. for a particular resource Rₖ, all intervals/sub-jobs of all tasks that use this resource (and protect it by using synchronization primitives) are either all preemptible or all non-preemptible—
   i. in case they are all preemptible the synchronization primitives must be executed, and
   ii. in case they are all non-preemptible, it is not necessary to execute the synchronization primitives;
3. preemption of a subset of tasks is limited to the preemption points of this subset while allowing arbitrary preemption of all the other tasks; and
4. preemption of a subset of tasks is limited to their preemption points, preemption of the other tasks is limited to a subset of their preemption points, while allowing arbitrary preemption of their remaining intervals.
   More concretely, when dealing with preemption points: the following steps must be taken:
Ensure that all protection primitives of a particular resource fall in the same sub-job (i.e., the critical section containing a pair of primitives does not cross sub-job boundaries.)
When a new task is started, the task manager/scheduler must take the protected resources into account, when it is determining which intervals are set to preemptible or to non-preemptible.

One trivial implementation of the above is to let the synchronization primitives coincide with preemption points. The drawback is that when synchronization primitives are invoked frequently in the code, a lot of small intervals are introduced.

A more generic implementation is the following. To the suspension data of an interval is added the identifiers Rₖ of the resources k that are protected in that interval. The scheduler/task manager can use this information to ensure that either all intervals using resource Rₖ are preemptible or they are all non-preemptible.
1. In a preferred embodiment, a middleware layer on top of a commercial-off-the-shelf (COTS) real-time operating system (RTOS) implements the functionality of the tests regarding memory usage and schedulability of tasks. This layer also decides which intervals are selected for preemption
   Whenever an interval tagged with Rₖ is selected for preemption, then all system calls having Rₖ as a parameter are passed to the RTOS by the middleware layer. Whenever no interval tagged with Rₖ is selected for preemption, then the middleware layer may ignore (i.e., immediately return from) the system call.

In a preferred embodiment, the method includes defining each task such that a pair of primitives does not span a task (or sub-job of the task) boundary, specifying a subset of task as preemptible or an non-preemptible depending on whether or not the task protect usage of at least one common resource, receiving first data identifying maximum memory and exclusive resource Rₖ usage associated with each of the plurality of tasks; receiving second data identifying memory available for processing the plurality of tasks; and identifying, on the basis of the first and second data, whether there is sufficient memory available to process the tasks. Monitoring, and suspending steps are then applied to tasks which can be preempted in the next interval and only in response to identifying insufficient memory.

Referring now to FIG. 5, suppose tasks are scheduled in accordance with a scheduling algorithm and a data structure is maintained for each task τᵢ after it has been created. Suppose further that a scheduler 501 employs a conventional priority-based, preemptive scheduling algorithm, which essentially ensures that, at any point in time, the currently running task is the one with the highest priority among all ready-to-run tasks in the system. As is known in the art, the scheduling behavior can be modified by selectively enabling and disabling preemption for the running, or ready-to-run, tasks based on memory requirements of the tasks.

A task manager 503 receives the suspension data 101 corresponding to a newly received task and evaluates whether or not preemption is required and possible and if it is required and possible, passes this newly received information to the scheduler 501, requesting preemption. The suspension data includes not only memory usage information but the resources Rₖ exclusively used by the task. Suppose details of the tasks are as defined in Table 2, and assume that task τ₁ (and only τ₁) is currently being processed and that the scheduler is initially operating in a mode in which there are no memory-based constraints.

Suppose now that task τ₂ is received by the task manager 503, which reads the suspension data 101 from its interface Int₂ 100, and identifies whether or not the scheduler 501 is working in accordance with memory- and resource-based preemption. Since, in this example, it is not, the task manager 503 evaluates whether the scheduler 501 needs to change to memory- and resource-based preemption. This therefore involves the task manager 503 retrieving worst case memory usage suspension data corresponding to all currently executing tasks (in this example task τ₁) from a suspension data store 505, evaluating Equation 1 and comparing the evaluated worst-case memory requirements with the memory resources available. Continuing with the example introduced in Table 2, Equation 1, for τ₁ and τ₂, is:

$${M}^{P} = {\sum }_{i = 1}^{2} {max}_{j = 1}^{m ( i )} {MI}_{i , j} = 0.7 + 0.8 = 1.5 Mbytes$$

This is exactly equal to the available memory, so there is no need to change the mode of operation of the scheduler 501 to memory- and resource-based preemption (i.e. there is no need to constrain the scheduler based on memory and exclusive resource usage). Thus, if the scheduler 501 were to switch between task τ₁ and task τ₂—e.g. to satisfy execution time constraints of task τ₂, meaning that both tasks effectively reside in memory at the same time and may be using their maximum amount of memory at the same time—the processor never accesses more memory than is available.

Next, and before tasks τ₁ and τ₂ have completed, another task τ₃ is received. The task manager 503 reads the suspension data 101 from interface Int₃ associated with the task τ₃, evaluating whether the scheduler 501 needs to change to memory- and resource-based preemption. Assuming that all three tasks are preemptible and that the scheduler 501 is multi-tasking tasks τ₁ and τ₂, the worst case memory requirements for all three tasks is now

$${M}^{P} = {\sum }_{i = 1}^{3} {max}_{j = 1}^{m ( i )} {MI}_{i , j} = 0.7 + 0.8 + 0.3 = 1.8 Mbytes$$

This exceeds the available memory, so the task manager 503 requests and retrieves memory usage data MP_{i,j}, MI_{i,j} 101b, 101d and preemptability data for all three tasks from the suspension data store 505, and evaluates whether, based on this retrieved memory usage and preemptability data, there are sufficient memory resources to execute all three tasks. This can be ascertained through evaluation of the following equation:

$$\begin{matrix}{M}^{ D} = {\sum }_{i = 1}^{3} {max}_{j = 1}^{m ( i )} {MP}_{i , j} + {max}_{i = 1}^{3} \\ ( {max}_{j = 1}^{m ( i )} {MI}_{i , j} - {max}_{j = 1}^{m ( i )} {MP}_{i , j} ) \\ = 0.2 + 0.2 + 0.1 + max ( 0.7 - 0.2 , 0.8 - 0.2 , 0.3 - 0.1 ) \\ = 0.5 + 0.6 \\ = 1.1 Mbytes .\end{matrix} \qquad ( Equation 2 )$$

This memory requirement is lower than the available memory, meaning that, provided the tasks are preempted based on their memory usage, all three tasks can be executed concurrently.

Accordingly, the task manager 503 invokes “memory- and resource-based preemption mode” by instructing the tasks to transmit deschedule instructions to the scheduler 501 at their designated preemption points MP_{i,j}. In this mode, the scheduler 501 allows. If a task's preemption data specifies exclusive use of a task set of resources Rₖ, then the scheduler instructs the operating system to execute all system calls with respect to resources Rₖ for all three tasks, the resources Rₖ being added to a system set of resources for which system calls are to be executed when the task begins execution.

In Table 3, RI_{i,j} is the set of resources protected by synchronization primitives in interval j of task i.

TABLE 3

| Task τ_{I} | MP_{i,1} | MI_{i,1} | RI_{i,1} | MP_{i,2} | MI_{i,2} | RI_{i,2} | MP_{i,3} | MI_{i,3} | RI_{i,3} |
|---|---|---|---|---|---|---|---|---|---|
| τ₁ | 0.2 | 0.7 | Rₐ | 0.2 | 0.4 | R_{c} | 0.1 | 0.6 | R_{c} |
| τ₂ | 0.1 | 0.5 | R_{b} | 0.2 | 0.8 | Rₐ | — | — | |
| τ₃ | 0.1 | 0.2 | R_{d} | 0.1 | 0.3 | R_{b} | — | — | |

When all intervals are non-preemptible, the system is schedulable. Also, in this case, there is no problem with synchronization of the resources and there is no need to execute the synchronization primitives.

However to reduce the latency of the system, it is possible to make some intervals preemptible without exceeding the available memory limits. For example, the system is still schedulable when:

τ₁ is only preempted at preemption points P_{1,1} and P_{1,3} and during interval I_{1,2}

τ₂ is only preempted at its preemption points

τ₃ is preempted arbitrarily

In Table 3, preemptible intervals are indicated in italics.

Suppose the priority of τ₁ is higher then the priority of τ₂, which in its in its turn is higher then τ₃ then the latency of τ₂ will be reduced because the intervals of τ₃ are preemptible. The task manager/scheduler must further ensure that all intervals protecting a certain resource are either all preemptible or either all non-preemptible. For R_{b} there is a problem: because I_{2,1} it is preemptible and I_{3,2} is not. The solution is to either make interval I_{2,1} also preemptible or I_{3.2} also not preemptible. Making I_{2,1} preemptible does not increase the memory requirements of the system and is therefore preferable (it reduces latency).

When one of the tasks has terminated, the terminating task informs the task manager 503 that it is terminating, causing the task manager 503 to remove the task's set of resources Rₖ from the system set of resources and then to evaluate Equation 1. If the worst case memory usage (taking into account removal of this task) is lower than that available to the scheduler 501, the task manager 503 can cancel memory- and resource-based preemption and clear the system set of resources, which has the benefit of enabling the system to react faster to external events (since the processor is no longer “blocked” for the duration of the sub-jobs). In general, termination of a task is typically caused by its environment, e.g. a switch of channel by the user or a change in the data stream of the encoding applied (requiring another kind of decoding), meaning that the task manager 503 and/or scheduler 501 should be aware of the termination of a task and probably even instruct the task to terminate.

Therefore, the method includes monitoring termination of tasks and repeating said step of identifying availability of memory and preemptability in response to a task terminating. In one embodiment, if, after a task has terminated, there is sufficient memory to execute the remaining tasks simultaneously, the monitoring step is deemed unnecessary and tasks are allowed to progress without any monitoring of inputs in relation to memory usage

In another preferred embodiment, a scheduler is provided for use in a data processing system, the data processing system being arranged to execute a plurality of tasks defined such that a synchronization primitive releasing resources matching another synchronization primitive protecting resources contained therein does not span a task boundary and having access to a specified amount of memory for use in executing the tasks, the scheduler comprising:

a data receiver arranged to receive data identifying maximum memory usage associated with a task, exclusive resource usage of the task, and preemptability of the task, wherein a subset of said plurality of tasks protecting usage of the same resource are all identified as one of preemptible or non-nonpreemptible;

an evaluator arranged to identify, on the basis of the received data, whether there is sufficient memory to execute the tasks;

a selector arranged to select at least one task for suspension during execution of the task, said suspension coinciding with a specified memory usage by the task and the task being preemptible;

wherein, in response to the evaluator identifying that there is insufficient memory to execute the plurality of tasks,
the selector selects at least one task for suspension, on the basis of its specified memory usage and its preemptability, and the specified amount of memory available to the data processing system,
the scheduler suspends execution of the at least one selected task in response to the task using the specified memory and the task being preemptible, and
the evaluator directs execution thereafter of synchronization primitives with respect to the protected resources of the suspended at least one task.

In this embodiment, the scheduler is implemented in one of hardware and software, and the data processing system is a high volume consumer electronics device such as a digital television system.

In another embodiment, there is provided a method of transmitting data to a data processing system, the method comprising:

defining a task such that a synchronization primitive that protects usage of a resource that matches another synchronization primitive contained therein does not span the task boundary;

defining all tasks as preemptible or as non-preemptible depending on whether or not the tasks protect usage of at least one same resource;

transmitting data for use by the data processing system in processing the task; and

transmitting suspension data specifying suspension of the task based on memory usage and preemptability during processing thereof,

wherein the data processing system is configured to perform a process comprising:

monitoring for an input indicative of memory usage of the task matching the suspension data associated with the task; and

if said suspension data specifies the task is preemptible, suspending processing of said task on the basis of said monitored input.

This embodiment is therefore concerned with the distribution of the suspension data corresponding to tasks to be processed by a data processing system. The suspension data is distributed as part of a regularly broadcasted signal (e.g. additional tasks with suspension data accompanying other sources), or distributed by a service provider as part of a general upgrade of data processing systems. Moreover, the data processing system can be updated via a separate link, or device (e.g. floppy-disk or CD-ROM).

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teaching of the present invention to a particular situation without departing from its central scope. Therefore it is intended that the present invention not be limited to the particular embodiments disclosed as the best mode contemplated for carrying out the present invention, but that the present invention include all embodiments falling within the scope of the appended claims.

### REFERENCES

The following references support corresponding references numbers in the text and are hereby included herein by reference as if fully set forth herein:
[1] R. Gopalakrishnan and G. M. Parulkar, “Bringing Real-Time Scheduling Theory And Practice Closer For Multimedia Computing,” In: Proc. ACM Sigmetrics Conf. on Measurement & modeling of computer systems, pp. 1-12, May 1996.
[2] S. Lee, C.-G. Lee, M. Lee, S. L. Min, and C.-S. Kim, “Limited Preemptible Scheduling to Embrace Cache Memory In Real-Time Systems,” In: Proc. ACM Sigplan Workshop on Languages, Compilers and Tools for Embedded Systems (LCTES), LNCS-1474, pp. 51-64, June 1998.
[3] J. Simonson and J. H. Patel, “Use Of Preferred Preemption Points In Cache-Based Real-Time Systems”, In: Proc IEEE International Computer Performance and Dependability Symposium (IPDS'95), pp. 316-325, April 1995.
[4] R. J. Bril and D. J. C. Lowet, “A Method For Handling Preemption Points,” Philips Research Laboratories, Eindhoven, The Netherlands, Internal IST/IPA document, 30 Sep. 2002.
[5] R. J. Bril and D. J. C. Lowet, “A Method For Handling Preemption Points—Remarks—,” Philips Research Laboratories, Eindhoven, The Netherlands, Internal IST/IPA document, 31 Oct. 2002.
[6] Clemens Szyperski, Component Software—Beyond Object-oriented Programming, Addison-Wesley, ISBN 0-201-17888-5, 1997.

1. A method of scheduling a plurality of tasks in a data processing system, comprising the steps of:
defining each task of said plurality such that a synchronization primitive releasing resources that matches another synchronization primitive protecting resources contained therein does not span a task boundary;
specifying a subset of tasks as preemptible or as non-preemptible depending on whether or not the tasks protect usage of at least one same resource;
for each task of the plurality, providing suspension data specifying suspension of the task based on memory used thereby and on the specified preemptability of the task;
processing one of the plurality of tasks;
monitoring for an input indicative of memory used by the task matching the suspension data associated with the task; and
if said suspension data specifies said task is preemptible, performing the steps of:
(i) suspending said task on the basis of said monitored input,
(ii) executing synchronization primitives with respect to the protected resources of the suspended task until said suspended task terminates, and
(ii) processing a different one of the plurality.

2. The method of claim 1, wherein said input comprises data indicative of a suspension request.

3. The method of claim 2, further comprising the steps of:
receiving first data identifying maximum memory usage associated with the plurality of tasks;
receiving second data identifying memory available for processing the plurality of tasks; and
identifying, on the basis of the first and second data, whether there is sufficient memory available to process the tasks;
wherein, said monitoring, suspending steps, and executing steps are performed only in response to identifying insufficient memory.

4. The method of claim 3, further comprising the steps of:
monitoring termination of tasks; and
in response to a task termination, repeating said step of identifying availability of memory in response to a task terminating.

5. The method of claim 4, in which, in response to identifying sufficient memory to execute the remaining tasks, the monitoring step is deemed unnecessary.

6. The method of claim 1, further comprising the steps of:
receiving first data identifying maximum memory usage associated with the plurality of tasks;
receiving second data identifying memory available for processing the plurality of tasks; and
identifying, on the basis of the first and second data, whether there is sufficient memory available to process the tasks;
wherein, said monitoring, suspending, and executing steps are performed only in response to identifying insufficient memory.

7. The method of claim 6, further comprising the steps of:
monitoring termination of tasks;
in response to a task termination, repeating said step of identifying availability of memory.

8. The method of claim 7, in which, in response to identifying sufficient memory to execute the remaining tasks, the monitoring step is deemed unnecessary.

9. The method of claim 1, further comprising the steps of:
receiving first data identifying maximum memory usage associated with the plurality of tasks;
receiving second data identifying memory available for processing the plurality of tasks; and
identifying, on the basis of the first and second data, whether there is sufficient memory available to process the tasks;
wherein, said monitoring, suspending, and executing steps are performed only in response to identifying insufficient memory.

10. The method claim 9, further comprising the steps of:
monitoring termination of tasks; and
in response to a task termination, repeating said step of identifying availability of memory.

11. The method according to claim 10, in which, in response to identifying sufficient memory to execute the remaining tasks, the monitoring step is deemed unnecessary.

12. A scheduler for use in a data processing system, the data processing system being arranged to execute a plurality of tasks defined such that a synchronization primitive releasing resources matching another synchronization primitive protecting resources contained therein does not span a task boundary and having access to a specified amount of memory for use in executing the tasks, the scheduler comprising:
a data receiver arranged to receive data identifying maximum memory usage associated with a task, exclusive resource usage of the task, and preemptability of the task, wherein a subset of said plurality of tasks protecting usage of the same resource are all identified as one of preemptible or non-nonpreemptible;
an evaluator arranged to identify, on the basis of the received data, whether there is sufficient memory to execute the tasks; and
a selector arranged to select at least one task for suspension during execution of the task, said suspension coinciding with a specified memory usage by the task and the task being preemptible;
wherein, in response to the evaluator identifying that there is insufficient memory to execute the plurality of tasks,
the selector selects at least one task for suspension, on the basis of its specified memory usage and its preemptability, and the specified amount of memory available to the data processing system,
the scheduler suspends execution of the at least one selected task in response to the task using the specified memory and the task being preemptible, and
the evaluator directs execution thereafter of synchronization primitives with respect to the protected resources of the suspended at least one task until said suspended at least one task terminates.

13. A scheduler according to claim 12, wherein the evaluator is further arranged to monitor termination of tasks, and in response to a task terminating, to identify whether there is sufficient memory to execute the remaining tasks.

14. A scheduler according to claim 13, wherein in response to the evaluator identifying sufficient memory to execute the remaining tasks the selector is arranged to deselect said selected at least one task.

15. A data processing system arranged to execute a plurality of tasks having each task of said plurality defined such that a synchronization primitive matching another synchronization primitive contained therein does not span a task boundary, the data processing system including:
memory arranged to hold instructions and data during execution of a task;
receiving means arranged to receive data identifying maximum memory usage associated with a task and data specifying preemptability of the task;
evaluating means arranged to identify, on the basis of the received data, whether there is sufficient memory to execute the tasks and whether the tasks are preemptible; and
a scheduler arranged to schedule execution of the tasks on the basis of input received from the evaluating means,
wherein, in response to identification of insufficient memory to execute the plurality of tasks,
the scheduler is arranged to suspend execution of at least one task in dependence on memory usage by the task, exclusive resource usage by the task, and preemptabilty of the task and to direct the execution thereafter of synchronization primitives with respect to the protected resources of the suspended at least one task until said suspended task terminates.

16. The data processing system of claim 15, wherein a subset of said plurality of tasks is determined be preemptible or non-preemptible depending on whether or not the subset of tasks protect usage of the same resource.

17. A method of transmitting data to a data processing system, the method comprising:
defining a task such that a synchronization primitive that protects usage of a resource that matches another synchronization primitive contained therein does not span the task boundary;
defining all tasks as preemptible or as non-preemptible depending on whether or not the tasks protect usage of at least one same resource;
transmitting data for use by the data processing system in processing the task; and
transmitting suspension data specifying suspension of the task based on memory usage and preemptability during processing thereof,
wherein the data processing system is configured to perform a process comprising:
monitoring for an input indicative of memory usage of the task matching the suspension data associated with the task; and
if said suspension data specifies the task is preemptible, suspending processing of said task on the basis of said monitored input and thereafter executing synchronization primitives with respect to the resources protected by the suspended task until the suspended task terminates.

18. A method according to claim 17, wherein the suspension data includes data identifying maximum memory usage associated with the task, exclusive resource usage associated with the task, and preemptability of the task.

19. A method according to claim 17, wherein the suspension data identifies at least one point at which processing of the task can be suspended, based on memory usage of the task, exclusive resource usage of the task, and preemptability of the task.

20. A method according to claim 19, wherein the task comprises a plurality of sub-jobs and said data identifying at least one point at which processing of the task can be suspended corresponds to each such sub-job that is preemptible.

21. A method according to claim 19, wherein the suspension data includes data identifying maximum memory usage associated with the task and exclusive resource usage associated with the task.

22. A method according to claim 21, wherein the task comprises a plurality of sub-jobs and said identifying at least one point at which processing of the task can be suspended corresponds to each such sub-job that is preemptible.

23. A method of configuring a task for use in a data processing system, the method including associating suspension data with the task, the suspension data specifying suspension of the task based on memory usage associated therewith, exclusive resource usage of the task, and preemptability of the task, wherein the data processing system is arranged to perform a process in respect of a plurality of tasks, the process comprising:
defining the task such that a synchronization primitive matching another synchronization primitive contain there does not span a task boundary;
monitoring for an input indicative of memory usage of the task matching the suspension data associated with the task; and
if the suspension data specifies said task is preemptible,
suspending processing of said task on the basis of said monitored input, and
executing thereafter synchronization primitives with respect to the exclusively used resources of the suspended at least one task until said task terminates.

24. A computer program stored in a memory, comprising a set of instructions arranged to cause a processing system to perform the method according to of claim 1.
